(19) United States
(12) Patent Application Publication
(10) Pub. No.: US 2015/0381414 A1
(43) Pub. Date: Dec. 31, 2015

(54) METHOD AND GATEWAY FOR AUTOMATICALLY CONTROLLING RELAYS AND WIRELESS SENSOR NETWORK

(71) Applicant: Tsinghua University, Beijing (CN)

(72) Inventors: KE XU, Beijing (CN); YI QU, Beijing (CN); WENLONG CHEN, Beijing (CN); DONGCHAO MA, Beijing (CN)

(21) Appl. No.: 14/586,336

(22) Filed: Dec. 30, 2014

(30) Foreign Application Priority Data
Jun. 27, 2014 (CN) 201410302726.0

(51) Int. Cl. H04L 12/24; H04W 84/18

(52) U.S. Cl. CPC H04L 41/0806; H04L 41/0816; H04W 84/18

(57) ABSTRACT

A method for automatically controlling relays is provided. The method includes: establishing a wireless sensor network comprising a gateway, a plurality of sensors connected with the gateway, a plurality of relays, and a plurality of terminals corresponding to the plurality of relays respectively and connected with the gateway via the plurality of relays; setting configuration information for each terminal and writing the configuration information into the gateway, where the configuration information of each terminal comprises operation parameters of the terminal, working modes related with the operation parameters, and sensors used for detecting environment parameters of the terminal; receiving by the gateway the environment parameters sent from the plurality of sensors; determining by the gateway whether the environment parameters detected by the sensors corresponding to the terminal are matched with the operation parameters of the terminal; and if yes, controlling the relay corresponding to the terminal to turn on.

### CROSS-REFERENCE TO RELATED APPLICATION

This application claims priority to and benefits of Chinese Patent Application Serial No. 201410302726.0, filed with the State Intellectual Property Office of P. R. China on Jun. 27, 2014, the entire content of which is incorporated herein by reference.

### FIELD

The present disclosure relates to a wireless communication field, and more particularly to a method and a relay for automatically controlling relays, and a wireless sensor network.

### BACKGROUND

In the related art, intelligent relays are connected with the internet in a wireless manner, and thus users may control the intelligent relays via mobile terminals such as mobile phones and tablet PCs, so as to control electrical equipments connected with the intelligent relays.

However, in the related art, the users must participate in the control, otherwise the intelligent relays are not capable of controlling the electrical equipments automatically. In addition, with growing popularity of household appliances, more and more electrical equipments are connected with the intelligent relays in one family, and thus it is inconvenient and boring for the user to control each relay. Moreover, once the user leaves the room, the electrical equipments may not be capable of working, thus reducing the user experience.

### SUMMARY

Embodiments of the present disclosure seek to solve at least one of the problems existing in the related art to at least some extent.

According to a first aspect of the present disclosure, a method for automatically controlling relays is provided. The method comprises: establishing a wireless sensor network, where the wireless sensor network comprises a gateway, a plurality of sensors connected with the gateway, a plurality of relays, and a plurality of terminals corresponding to the plurality of relays respectively and connected with the gateway via the plurality of relays; setting configuration information for each of the plurality of terminals and writing the configuration information into the gateway, where the configuration information of each terminal comprises operation parameters of the terminal, working modes related with the operation parameters, and sensors used for detecting environment parameters of the terminal; receiving by the gateway the environment parameters sent from the plurality of sensors; determining by the gateway whether the environment parameters detected by the sensors corresponding to the terminal are matched with the operation parameters of the terminal; and if yes, controlling the relay corresponding to the terminal to turn on, so as to control the terminal to work in a corresponding working mode.

With the method for automatically controlling relays according to embodiments of the present disclosure, by establishing the wireless sensor network, writing configuration information of the terminals into the relay, matching detected environment parameters with the working parameters in the configuration information, and controlling the relay to turn on when the matching is successful, the terminal is controlled to work in the working mode corresponding to the working parameters matched with the environment parameters, thus realizing an automatic and convenient control to the terminals and improving the user experience.

In some embodiments of the present disclosure, when a connection relationship between the plurality of relays and the plurality of terminals changes, configuration information for the plurality of terminals may be reset.

In some embodiments of the present disclosure, when the environment parameters detected by the sensors corresponding to the terminal are not matched with the operation parameters in the configuration information of the terminal, the environment parameters detected by the sensors corresponding to the terminal and the operation parameters of the terminal are sent from the gateway to a mobile terminal, and the working mode of the terminal is adjusted according to an instruction feedback from the mobile terminal.

In some embodiments of the present disclosure, when no instruction is feedback from the mobile terminal within a predetermined period, the working mode of the terminal is adjusted automatically.

In some embodiments of the present disclosure, the mobile terminal is connected with the gateway directly or via an internet, and the relays are intelligent relays.

According to a second aspect of the present disclosure, a wireless sensor network is provided. The wireless sensor network comprises: a plurality of relays; a plurality of terminals connected with the plurality of relays respectively; a plurality of sensors, configured to detect environment parameters of the plurality of terminals; and a gateway, connected with the plurality of terminals and the plurality of sensors respectively, and configured to store configuration information of each terminal comprising operation parameters, working modes related with the operation parameters and sensors used for detecting environment parameters of the terminal, to receive the environment parameters detected by the plurality of sensors, to determine whether the environment parameters detected by the sensors corresponding to the terminal are matched with the operation parameters of the terminal, and if yes, to control the relay corresponding to the terminal to turn on, such that the terminal is controlled to work in a corresponding working mode.

With the wireless sensor network according to embodiments of the present disclosure, by storing configuration information of the terminals in the relay, matching environment parameters detected by the sensors with the working parameters in the configuration information, and controlling the relay to turn on when the matching is successful, the terminal is controlled to work in the working mode corresponding to the working parameters matched with the environment parameters, thus realizing an automatic and convenient control to the terminals and improving the user experience.

In some embodiments, the gateway is further configured to reset configuration information for the plurality of terminals when a connection relationship between the plurality of relays and the plurality of terminals changes.

In some embodiments, the wireless sensor network further comprises a mobile terminal. The mobile terminal is configured to receive the environment parameters detected by the sensors corresponding to the terminal and the operation parameters of the terminal from the gateway when the environment parameters detected by the sensors corresponding to the terminal are not matched with the operation parameters of the terminal, and to feedback an instruction for adjusting the working mode to the gateway.

In some embodiments, the gateway is further configured to adjust the working mode of the terminal according to the instruction feedback from the mobile terminal.

In other embodiments, the gateway is further configured to adjust the working mode of the terminal automatically when no instruction is received from the mobile terminal within a predetermined period.

In some embodiments, the mobile terminal is connected with the gateway directly or via an internet, and the relays are intelligent relays.

According to a third aspect of the present disclosure, a gateway for automatically controlling relays is provided. The gateway is connected with a plurality of sensors and a plurality of relays respectively, the plurality of relays are connected with a plurality of terminals respectively, and the gateway comprises: a storing module, configured to store configuration information of each terminal, in which the configuration information of the terminal comprises operation parameters, working modes related with the operation parameters and sensors used for detecting environment parameters of the terminal; a receiving module, configured to receive the environment parameters detected by the plurality of sensors; a determining module, configured to determine whether the environment parameters detected by the sensors corresponding to the terminal are matched with the operation parameters in the configuration information of the terminal; and a control module, configured to control the relay corresponding to the terminal to turn on when the environment parameters detected by the sensors corresponding to the terminal are matched with the operation parameters of the terminal, such that the terminal is controlled to work in a corresponding working mode.

With the gateway for automatically controlling relays according to embodiments of the present disclosure, by storing configuration information of the terminals in the relay, matching environment parameters detected by the sensors with the working parameters in the configuration information, and controlling the relay to turn on when the matching is successful, the terminal is controlled to work in the working mode corresponding to the working parameters matched with the environment parameters, thus realizing an automatic and convenient control to the terminals and improving the user experience.

In some embodiments, the configuration information of the terminals are reset when a connection relationship between the plurality of relays and the plurality of terminals changes.

In some embodiments, the gateway further comprises a sending module. The sending module is configured to send the environment parameters detected by the sensors corresponding to the terminal and the operation parameters of the terminal to a mobile terminal when the environment parameters detected by the sensors corresponding to the terminal are not matched with the operation parameters in the configuration information of the terminal, and the control module is further configured to adjust the working mode of the terminal according to an instruction feedback from the mobile terminal.

In some embodiments, the control module is further configured to adjust the working mode of the terminal automatically when no instruction is received from the mobile terminal within a predetermined period.

In some embodiments, the gateway is connected with the mobile terminal directly or via an internet.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is flow chart of a method for automatically controlling relays according to embodiments of the present disclosure;

FIG. 2 is a topological graph of a wireless sensor network according to an embodiment of the present disclosure;

FIG. 3 is a flow chart of a method for automatically controlling relays according to another embodiment of the present disclosure;

FIG. 4 is a schematic diagram showing an information configuration for terminals connected with relays;

FIG. 5 is a schematic diagram showing an automatic control to the terminals;

FIG. 6 is a block diagram of a wireless sensor network according to an embodiment of the present disclosure; and

FIG. 7 is a block diagram of a gateway for automatically controlling relays according to an embodiment of the present disclosure.

### DETAILED DESCRIPTION

Reference will be made in detail to embodiments of the present disclosure. The embodiments described herein with reference to drawings are explanatory, illustrative, and used to generally understand the present disclosure. The embodiments shall not be construed to limit the present disclosure. The same or similar elements and the elements having same or similar functions are denoted by like reference numerals throughout the descriptions.

In the specification, unless specified or limited otherwise, relative terms such as “central”, “longitudinal”, “lateral”, “front”, “rear”, “right”, “left”, “inner”, “outer”, “lower”, “upper”, “horizontal”, “vertical”, “above”, “below”, “up”, “top”, “bottom” as well as derivative thereof (e.g., “horizontally”, “downwardly”, “upwardly”, etc.) should be construed to refer to the orientation as then described or as shown in the drawings under discussion. These relative terms are for convenience of description and do not require that the present disclosure be constructed or operated in a particular orientation.

In the description of the present disclosure, it should be understood that, unless specified or limited otherwise, the terms “mounted,” “connected,” and “coupled” and variations thereof are used broadly and encompass such as mechanical or electrical mountings, connections and couplings, also can be inner mountings, connections and couplings of two components, and further can be direct and indirect mountings, connections, and couplings, which can be understood by those skilled in the art according to the detail embodiment of the present disclosure.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present invention, “a plurality of” means two or more than two, unless specified otherwise.

With rapid development of hardware chips and wireless communication technology, sensors tend toward miniaturization and diversification. Moreover, people pay more and more attention to their living environment, and more and more sensors such as temperature sensors and humidity sensors are used in the daily life. Thus, a method for automatically controlling relays based on the sensors is provided in the present disclosure, which has a high degree of automation and is convenient.

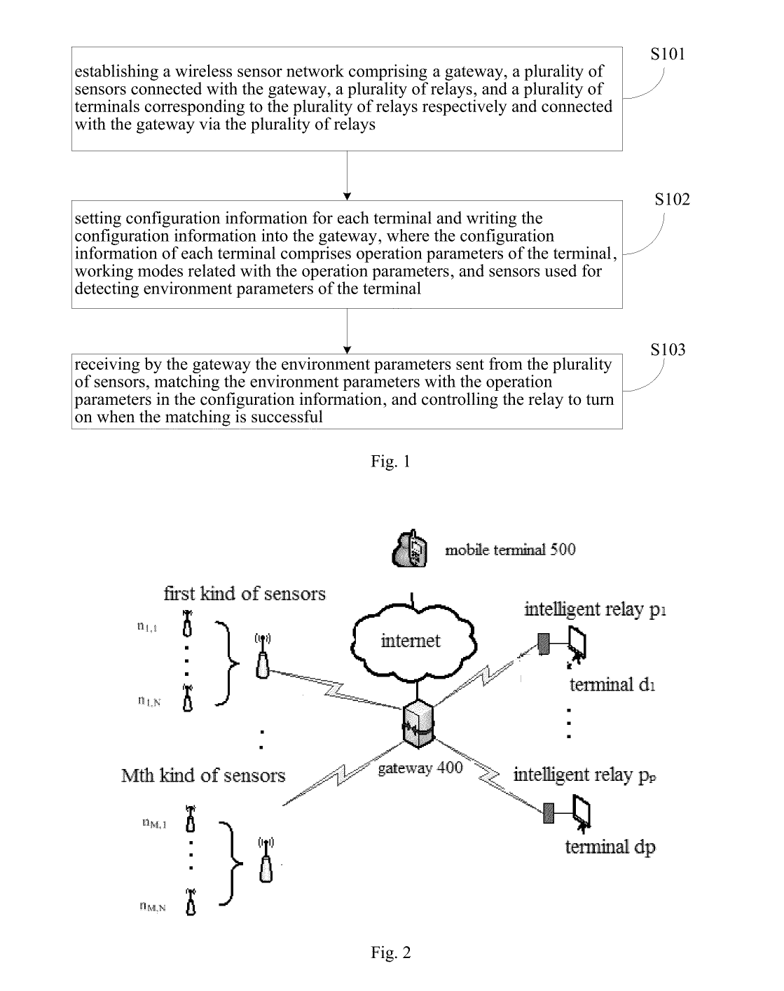

FIG. 1 is a flow chart of a method for automatically controlling relays according to an embodiment of the present disclosure. As shown in FIG. 1, the method includes following steps.

At step S101, a wireless sensor network is established. The wireless sensor network comprises a gateway, a plurality of sensors connected with the gateway, a plurality of relays, and a plurality of terminals corresponding to the plurality of relays respectively and connected with the gateway via the plurality of relays.

Specifically, in some embodiments of the present disclosure, the gateway has many kinds of communication interfaces, which can be connected to the internet, or connected with a mobile terminal such as a mobile phone or a tablet PC directly, or connected with the mobile terminal via the internet. In addition, the gateway may also connect sensor information from the sensors and control the relays. Advantageously, the relays in the present disclosure are intelligent relays.

Further, in some embodiments of the present disclosure, the intelligent relays are connected with the gateway in a wireless communication manner. With reference to FIG. 2, the intelligent relays are denoted as pᵢ, (iε1 . . . P), in which P is the number of intelligent relays in the wireless sensor network.

Further, in some embodiments of the present disclosure, the sensors may be connected with the gateway in the wireless communication manner, and notify their location information to the gateway. With reference to FIG. 2, the sensors are denoted as n_{i,j}, (iε1 . . . M,jε1 . . . N), in which M is the number of kinds of the sensors in the wireless sensor network, and N is the number of each kind of sensors.

At step S102, configuration information is set for each of the plurality of terminals and the configuration information are written into the gateway. The configuration information of each terminal comprises operation parameters of the terminal, working modes related with the operation parameters, and sensors used for detecting environment parameters of the terminal.

Specifically, in some embodiments, the terminals may be electrical equipments. For example, the electrical equipments are connected with the intelligent relays to obtain power, and the gateway controls the intelligent relays in the wireless manner, so as to realize a control to the electrical equipments connected with the intelligent gateways. Further, the user performs a control mode configuration on the terminal connected with each intelligent relay (i.e. set configuration information for each terminal), and the control mode information is stored in the gateway (i.e. the configuration information is written into the gateway). The configuration information is the basis for automatically controlling the relays.

In some embodiments of the present disclosure, the terminal connected with the intelligent relay pᵢ is denoted as dᵢ. The user determines the environment parameters Eᵢ which are required to be monitored according to the characteristics of the terminal dᵢ. Eᵢ is a parameter set, an element in which is a specific environment parameter, and the number of the elements can be denoted as |Eᵢ|. The sensors responsible for monitoring the environment parameter eₖ(eₖεEᵢ) are the k^{th} kind of sensors, and the user selects a certain sensor which is close to the terminal dᵢ to monitor the terminal dᵢ. Moreover, for each element eₖ(eₖεEᵢ), it can be corresponding to the k^{th} kind of operation operationₖ of the intelligent relay, or not be corresponding to any operation (i.e. null). Further, the user determines L kinds of control modes for the terminal, and each kind of control mode is corresponding to one specific working mode of the terminal. The control mode can be denoted as modeⱼ, j={1, 2 . . . L}. modeⱼ is a set including value ranges, and each element in modeⱼ is corresponding to a value range of one element in the set Eᵢ. For example, modeⱼ={[e₁^{j,low},e₁^{j,high}], [e₂^{j,low},e₂^{j,high}] . . . , [eₖ^{j,low},eₖ^{j,high}], . . . [e_{|E}_{ᵢ}_{|}^{j,low},e_{|E}_{ᵢ}_{|}^{j,high}]}, in which [eₖ^{j,low},eₖ^{j,high}] indicates the value range of the element eₖ(eₖεEᵢ), i.e., eₖ^{j,low}≦eₖ≦eₖ^{j,high}.

Further, in some embodiments of the present disclosure, when a connection relationship between the plurality of relays and the plurality of terminal changes, the control modes for each terminal are reset. In other words, for each intelligent relay and the electrical equipment connected therewith, the control mode configuration should be performed, and once the connection relationship between the electrical equipment and the connected intelligent relay changes, the control mode configuration should be performed again.

At step S103, the gateway receives the sensor information detected by the plurality of sensors, matches the sensor information with the operation parameters in the configuration information, and controls a corresponding relay to turn on when a matching is successful, such that the successfully matched terminal works in the corresponding working mode according to the sensor information.

Specifically, the gateway collects the sensor information, and all the collected sensor information may be denoted as a matrix S_{M,N},

$${S}_{M , N} = \{ \begin{matrix}{s}_{1 , 1} & … & {s}_{1 , 2} \\ ⋮ & {s}_{i , j} & ⋮ \\ {s}_{M , 1} & … & {s}_{M , N}\end{matrix} \} ,$$

in which s_{i,j} is the sensor information detected by the sensor n_{i,j}. For example, for the terminal dᵢ, corresponding sensor information is selected from the matrix S_{M,N} according to the above configuration information firstly to obtain the environment parameter set E′ᵢ={e′₁, e′₂, . . . e′ₖ . . . , e′_{|E}_{ᵢ}_{|}} of the terminal dᵢ, in which e′ₖ is obtained from the matrix S_{M,N}. For example, a certain element eₐ in E′ᵢ is corresponding to the sensor n_{a,b}, i.e. e′ₐ=s_{a,b}. After obtaining E′ᵢ, each control mode of the terminal dᵢ is matched with the element in E′ᵢ. If for any k (1≦k≦|Eᵢ|), eₖ^{j,low}≦eₖ≦eₖ^{j,high} is satisfied, the current environment parameters are matched with the mode modeⱼ, and the gateway controls the terminal to work in modeⱼ. In other words, when the matching is successful, the gateway controls the corresponding relay to turn on, so as to control the successfully matched terminal to work in a corresponding working mode according to the sensor information, without the participation of the user, thus having a high degree of automation and being convenient for use.

In other embodiments of the present disclosure, when the matching is not successful, the gateway sends the sensor information detected by the sensors and the current working mode of the terminal corresponding to the sensors to a mobile terminal, and adjusts the working mode of the terminal according to an instruction feedback from the mobile terminal. In other words, if the current environment parameters cannot be matched with any mode, the current operation parameters and environment parameters are sent to the mobile terminal of the user, and then the working mode of the terminal is adjusted according to the requirements of the user after receiving the instruction feedback from the user.

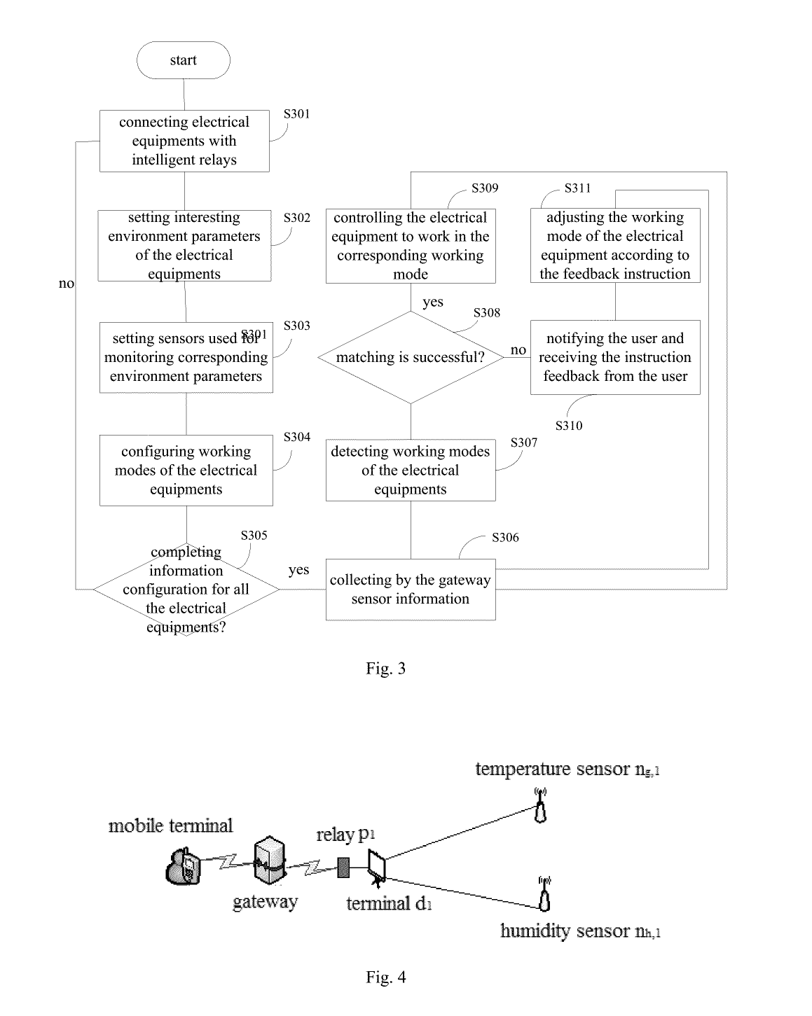

The above control method will be described in detail below with reference to FIG. 3. Referring to FIG. 3, the control method includes following steps.

At step S301, the electrical equipments are connected with the intelligent relays. In other words, the wireless sensor network is established.

At step S302, the interesting environment parameters of the electrical equipments are set.

At step S303, the sensors used for monitoring corresponding environment parameters are set.

At step S304, the working modes of the electrical equipments are configured.

In one embodiment, the user sets working modes for each electrical equipment respectively, and then writes the configuration information into the gateway.

At step S305, it is determined whether the information configuration for all the electrical equipments has been completed, if yes, execute step S306, and if no, return to step S301.

At step S306, the gateway collects the sensor information.

At step S307, the working modes of the electrical equipments are detected.

In one embodiment, the gateway receives the sensor information detected by the sensors, and matches the sensor information with the operation parameters in the configuration information.

At step S308, it is determined whether the matching is successful, if yes, execute step S309, and if no, execute step S310.

At step S309, the electrical equipment works in the corresponding working mode.

When the matching is successful, the gateway controls the corresponding relay to turn on, so as to control the successfully matched terminal to work in the corresponding working mode according to the sensor information.

At step S310, the gateway notifies the user, and receives the instruction feedback from the user.

At step S311, the gateway adjusts the working mode of the electrical equipment according to the feedback instruction.

In one embodiment, if no instruction is received from the mobile terminal within a predetermined period, the working mode of the terminal is adjusted automatically. In other words, if no instruction is feedback from the user, the working mode is adjusted automatically according to the environment parameters. For example, if the terminal dᵢ works in modeₐ currently, and e′_{b}≧e_{b}^{j,high} at this time, operation_{b} is performed on the terminal dᵢ.

FIG. 4 is a schematic diagram showing an information configuration for terminals connected with relays. As shown in FIG. 4, the user firstly determines the interesting environment parameters of each equipment according to the characteristics of the equipment. For example, the equipment dᵢ is an air-conditioner, the interesting environment parameters thereof are temperature e_{g} and humidity eₕ, and then the user associates the equipment with the temperature sensor n_{g,1} and the humidity sensor n_{h,1}. Two environment parameters are corresponding to two operations, i.e. temperature adjustment and humidity adjustment. Then the user sets the working modes of the equipment as follows: off mode mode₁={[19° C., 24° C.], [40%, 60%]}, refrigeration mode mode₂={[24° C., +∞], [ ]}, heating mode mode₃={[0° C., 19° C.], [ ]}, and dehumidification mode mode₄={[ ], [60%, +∞]}.

Further, as shown in FIG. 5, after information configuration of the equipment, the gateway can control the equipment automatically, and the basis of the control is the sensor information detected by the sensors. For example, when the temperature sensor sends the current temperature e_{g}=20.5° C. to the gateway and the humidity sensor sends the current humidity eₕ=40.7% to the gateway, the gateway matches the current environment parameters with the configuration information set by the user, and determines that the current environment parameters are matched successfully with the off mode mode₁ set by the user, i.e. 20° C.≦e_{g}≦40° C. and 40%≦eₕ≦60%. Then, the gateway cuts off the power supply of the intelligent relay to turn off the equipment, thus realizing an automatic control to the equipment dᵢ.

With the method for automatically controlling relays according to embodiments of the present disclosure, by establishing the wireless sensor network, writing configuration information of the terminals into the relay, matching detected environment parameters with the working parameters in the configuration information, and controlling the relay to turn on when the matching is successful, the terminal is controlled to work in the working mode corresponding to the working parameters matched with the environment parameters, thus realizing an automatic and convenient control to the terminals and improving the user experience.

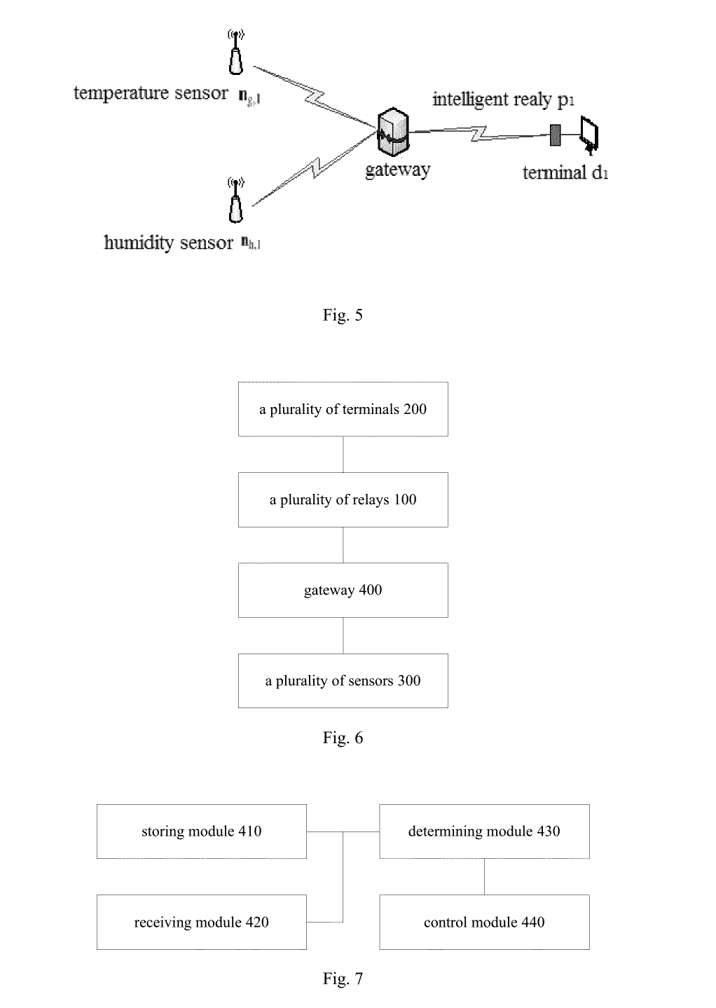

A wireless sensor network is also provided in the present disclosure. FIG. 6 is a block diagram of a wireless sensor network according to an embodiment of the present disclosure. As shown in FIG. 6, the wireless sensor network comprises a plurality of relays 100, a plurality of terminals 200, a plurality of sensors 300 and a gateway 400.

The plurality of relays 100 are corresponding to the plurality of terminals 200 respectively. The plurality of sensors 300 are configured to detect environment parameters of the plurality of terminals 200. The gateway 400 is connected with the plurality of sensors 300 and the plurality of relays 100 respectively, and connected with the plurality of terminals 200 via the plurality of relays 100. The gateway 400 is configured to store configuration information of each terminal comprising operation parameters, working modes related with the operation parameters and sensors used for detecting environment parameters of the terminal, to receive the environment parameters detected by the plurality of sensors, to determine whether the environment parameters detected by the sensors and corresponding to the terminal are matched with the operation parameters of the terminal, and if yes, to control the relay corresponding to the terminal to turn on, such that the terminal is controlled to work in a corresponding working mode.

Advantageously, the relays 100 are intelligent relays.

In one embodiment of the present disclosure, the wireless sensor network may further comprise a mobile terminal. As shown in FIG. 2, there are five kinds of equipments in the wireless sensor network, i.e. the gateway 400 responsible for communication and automatic control, the mobile terminal 500, the plurality of sensors 300, the plurality of relays 100 and the plurality of terminals 200 connected with the relays. The mobile terminal 500 may be connected with the gateway directly in a wireless communication manner, or connected with the gateway 400 via the internet. The terminals 200 may be any kind of electrical equipments which needs power supply, such as household appliances, for example, a television and an air-conditioner. The terminals are connected with the intelligent relays via power lines to obtain power supply, and the intelligent relays 100 are connected with the gateway 400 via the wireless communication. In FIG. 2, there are many kinds of sensors, such as temperature sensors and humidity sensors. Each kind of sensors includes one or more sensors, which can be connected with the gateway via the wireless communication.

Specifically, the gateway 400 has many kinds of communication interfaces, which can be connected with the internet, or connected with the mobile terminal 500 such the mobile phone and the tablet PC directly, or connected with the mobile terminal 500 via the internet. In addition, the gateway 400 can connect the sensor information from the sensors and control the relays.

In one embodiment, the gateway 400 is further configured to reset configuration information for the plurality of terminals 200 when a connection relationship between the plurality of relays 100 and the plurality of terminals 200 changes. In other words, for each intelligent relay and the electrical equipment connected with the intelligent relays, a control mode configuration should be performed, and once the connection relationship between the electrical equipment and the intelligent relay changes, the control mode configuration should be performed again.

In one embodiment, when the matching is not successful, the gateway 400 sends the environment parameters detected by the sensors corresponding to the terminal and the operation parameters of the terminal to the mobile terminal 500, and adjusts the working mode of the terminal according to an instruction feedback from the mobile terminal 500.

In other embodiments, when no instruction is feedback from the mobile terminal 500 within a predetermined period, the gateway 400 adjusts the working mode of the terminal automatically according to the environment parameters detected by the sensors.

With the wireless sensor network according to embodiments of the present disclosure, by storing configuration information of the terminals in the relay, matching environment parameters detected by the sensors with the working parameters in the configuration information, and controlling the relay to turn on when the matching is successful, the terminal is controlled to work in the working mode corresponding to the working parameters matched with the environment parameters, thus realizing an automatic and convenient control to the terminals and improving the user experience.

A gateway for automatically controlling relays is also provided in the present disclosure. FIG. 7 is block diagram of a gateway according to an embodiment of the present disclosure. the gateway is connected with a plurality of sensors and a plurality of relays respectively, the plurality of relays are connected with a plurality of terminals respectively. As shown in FIG. 7, the gateway comprises a storing module 410, a receiving module 420, a determining module 430 and a control module 440.

The storing module 410 is configured to store configuration information of each terminal, in which the configuration information of the terminal comprises operation parameters, working modes related with the operation parameters and sensors used for detecting environment parameters of the terminal. The receiving module 420 is configured to receive the environment parameters detected by the plurality of sensors. The determining module 430 is configured to determine whether the environment parameters detected by the sensors corresponding to the terminal are matched with the operation parameters in the configuration information of the terminal. The control module 440 is configured to control the relay corresponding to the terminal to turn on when the environment parameters detected by the sensors corresponding to the terminal are matched with the operation parameters of the terminal, such that the terminal is controlled to work in a corresponding working mode.

In one embodiment of the present disclosure, the configuration information of the terminals are reset when a connection relationship between the plurality of relays and the plurality of terminals changes.

In some embodiments, the gateway may further comprise a sending module (not shown). The sending is configured to send the environment parameters detected by the sensors corresponding to the terminal and the operation parameters of the terminal to a mobile terminal when the environment parameters detected by the sensors corresponding to the terminal are not matched with the operation parameters in the configuration information of the terminal, and the control module 440 is further configured to adjust the working mode of the terminal according to an instruction feedback from the mobile terminal. In some embodiments, the gateway may be connected with the mobile terminal directly or via the internet.

In other embodiments, the control module 440 is further configured to adjust the working mode of the terminal automatically when no instruction is received from the mobile terminal within a predetermined period.

With the gateway for automatically controlling relays according to embodiments of the present disclosure, by storing configuration information of the terminals in the relay, matching environment parameters detected by the sensors with the working parameters in the configuration information, and controlling the relay to turn on when the matching is successful, the terminal is controlled to work in the working mode corresponding to the working parameters matched with the environment parameters, thus realizing an automatic and convenient control to the terminals and improving the user experience.

Reference throughout this specification to “an embodiment,” “some embodiments,” “one embodiment”, “another example,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although explanatory embodiments have been shown and described, it would be appreciated by those skilled in the art that the above embodiments cannot be construed to limit the present disclosure, and changes, alternatives, and modifications can be made in the embodiments without departing from spirit, principles and scope of the present disclosure.

What is claimed is:

1. A method for automatically controlling relays, comprising:
establishing a wireless sensor network, wherein the wireless sensor network comprises a gateway, a plurality of sensors connected with the gateway, a plurality of relays, and a plurality of terminals corresponding to the plurality of relays respectively and connected with the gateway via the plurality of relays;
setting configuration information for each of the plurality of terminals and writing the configuration information into the gateway, wherein the configuration information of each terminal comprises operation parameters of the terminal, working modes related with the operation parameters, and sensors used for detecting environment parameters of the terminal;
receiving by the gateway the environment parameters sent from the plurality of sensors;
determining by the gateway whether the environment parameters detected by the sensors corresponding to the terminal are matched with the operation parameters of the terminal; and
if yes, controlling the relay corresponding to the terminal to turn on, so as to control the terminal to work in a corresponding working mode.

2. The method according to claim 1, further comprising:
resetting configuration information for the plurality of terminals when a connection relationship between the plurality of relays and the plurality of terminals changes.

3. The method according to claim 1, further comprising:
sending the environment parameters detected by the sensors corresponding to the terminal and the operation parameters of the terminal from the gateway to a mobile terminal when the environment parameters detected by the sensors corresponding to the terminal are not matched with the operation parameters in the configuration information of the terminal; and
adjusting the working mode of the terminal according to an instruction feedback from the mobile terminal.

4. The method according to claim 3, further comprising:
adjusting the working mode of the terminal automatically when no instruction is feedback from the mobile terminal within a predetermined period.

5. The method according to claim 3, wherein the mobile terminal is connected with the gateway directly or via an internet.

6. The method according to claim 1, wherein the relays are intelligent relays.

7. A wireless sensor network, comprising:
a plurality of relays;
a plurality of terminals connected with the plurality of relays respectively;
a plurality of sensors, configured to detect environment parameters of the plurality of terminals; and
a gateway, connected with the plurality of terminals and the plurality of sensors respectively, and configured to store configuration information of each terminal comprising operation parameters, working modes related with the operation parameters and sensors used for detecting environment parameters of the terminal, to receive the environment parameters detected by the plurality of sensors, to determine whether the environment parameters detected by the sensors and corresponding to the terminal are matched with the operation parameters of the terminal, and if yes, to control the relay corresponding to the terminal to turn on, such that the terminal is controlled to work in a corresponding working mode.

8. The wireless sensor network according to claim 7, wherein the gateway is further configured to reset configuration information for the plurality of terminals when a connection relationship between the plurality of relays and the plurality of terminals changes.

9. The wireless sensor network according to claim 7, further comprising:
a mobile terminal, configured to receive the environment parameters detected by the sensors corresponding to the terminal and the operation parameters of the terminal from the gateway when the environment parameters detected by the sensors corresponding to the terminal are not matched with the operation parameters of the terminal, and to feedback an instruction for adjusting the working mode to the gateway.

10. The wireless sensor network according to claim 9, wherein the gateway is further configured to adjust the working mode of the terminal according to the instruction feedback from the mobile terminal.

11. The wireless sensor network according to claim 9, wherein the gateway is further configured to adjust the working mode of the terminal automatically when no instruction is received from the mobile terminal within a predetermined period.

12. The wireless sensor network according to claim 9, wherein the mobile terminal is connected with the gateway directly or via an internet.

13. The wireless sensor network according to claim 9, wherein the mobile terminal comprises a mobile phone and a tablet PC.

14. The wireless sensor network according to claim 7, wherein the relays are intelligent relays.

15. A gateway for automatically controlling relays, wherein the gateway is connected with a plurality of sensors and a plurality of relays respectively, the plurality of relays are connected with a plurality of terminals respectively, and the gateway comprises:
a storing module, configured to store configuration information of each terminal, in which the configuration information of the terminal comprises operation parameters, working modes related with the operation parameters and sensors used for detecting environment parameters of the terminal;
a receiving module, configured to receive the environment parameters detected by the plurality of sensors;
a determining module, configured to determine whether the environment parameters detected by the sensors corresponding to the terminal are matched with the operation parameters in the configuration information of the terminal; and
a control module, configured to control the relay corresponding to the terminal to turn on when the environment parameters detected by the sensors corresponding to the terminal are matched with the operation parameters of the terminal, such that the terminal is controlled to work in a corresponding working mode.

16. The gateway according to claim 15, wherein the configuration information of the terminals are reset when a connection relationship between the plurality of relays and the plurality of terminals changes.

17. The gateway according to claim 15, further comprising:
a sending module, configured to send the environment parameters detected by the sensors corresponding to the terminal and the operation parameters of the terminal to a mobile terminal when the environment parameters detected by the sensors corresponding to the terminal are not matched with the operation parameters in the configuration information of the terminal, and
wherein the control module is further configured to adjust the working mode of the terminal according to an instruction feedback from the mobile terminal.

18. The gateway according to claim 17, wherein the control module is further configured to adjust the working mode of the terminal automatically when no instruction is received from the mobile terminal within a predetermined period.

19. The gateway according to claim 17, wherein the gateway is connected with the mobile terminal directly or via the internet.
